(19) United States
(12) Patent Application Publication
(10) Pub. No.: US 2025/0240662 A1
(43) Pub. Date: Jul. 24, 2025

(54) PREAMBLE SENDING METHOD, TERMINAL, AND STORAGE MEDIUM

(71) Applicant: VIVO MOBILE COMMUNICATION CO., LTD., Dongguan (CN)

(72) Inventors: Dajie JIANG, Dongguan (CN); Jian YAO, Dongguan (CN); Wei BAO, Dongguan (CN)

(73) Assignee: VIVO MOBILE COMMUNICATION CO., LTD., Dongguan (CN)

(21) Appl. No.: 19/082,129

(22) Filed: Mar. 17, 2025

Related U.S. Application Data
(63) Continuation of application No. PCT/CN2023/118441, filed on Sep. 13, 2023.

(30) Foreign Application Priority Data
Sep. 20, 2022 (CN) 202211146481.8

(51) Int. Cl. H04W 24/10; H04W 24/08

(52) U.S. Cl. CPC H04W 24/10; H04W 24/08

(57) ABSTRACT

This application discloses a preamble sending method, a terminal, and a storage medium. The preamble sending method includes: A terminal measures a first signal to obtain a target measurement result, where the target measurement result includes a sensing measurement result; and the terminal sends a preamble based on the target measurement result.

### CROSS-REFERENCE TO RELATED APPLICATIONS

This application is a continuation of International Application No. PCT/CN2023/118441, filed Sep. 13, 2023, which claims priority to Chinese Patent Application No. 202211146481.8, filed Sep. 20, 2022. The entire contents of each of the above-referenced applications are expressly incorporated herein by reference.

### TECHNICAL FIELD

This application pertains to the field of communication technologies, and specifically relates to a preamble sending method, a terminal, and a storage medium.

### BACKGROUND

In a four-step random access procedure or a two-step random access procedure, a terminal needs to send a preamble to a network-side device. For example, the terminal sends a preamble in a Message 1 (MSG 1) in the four-step random access procedure, or sends a preamble in a message A (MSG A) in the two-step random access procedure. However, in practical study, it is found that currently, before sending the preamble, the terminal sends the preamble only based on a measurement result related to communication. Consequently, in a case that the terminal that sends the preamble cannot meet a wireless sensing requirement, sensing performance of the terminal is poor.

### SUMMARY

Embodiments of this application provide a preamble sending method, a terminal, and a storage medium.

According to a first aspect, a preamble sending method is provided, including:
measuring, by a terminal, a first signal to obtain a target measurement result, where the target measurement result includes a sensing measurement result; and
sending, by the terminal, a preamble based on the target measurement result.

According to a second aspect, a preamble sending apparatus is provided, including:
a measurement module, configured to measure a first signal to obtain a target measurement result, where the target measurement result includes a sensing measurement result; and
a sending module, configured to send a preamble based on the target measurement result.

According to a third aspect, a terminal is provided. The terminal includes a processor and a memory, the memory stores a program or instructions capable of running on the processor, and when the program or the instructions are executed by the processor, the steps of the preamble sending method provided in the embodiments of this application are implemented.

According to a fourth aspect, a terminal is provided. The terminal includes a processor and a communication interface. The communication interface is configured to: measure a first signal to obtain a target measurement result, where the target measurement result includes a sensing measurement result; and send a preamble based on the target measurement result.

According to a fifth aspect, a readable storage medium is provided. The readable storage medium stores a program or instructions, and when the program or the instructions are executed by a processor, the steps of the preamble sending method provided in the embodiments of this application are implemented.

According to a sixth aspect, a chip is provided. The chip includes a processor and a communication interface, the communication interface is coupled to the processor, and the processor is configured to run a program or instructions to implement the preamble sending method provided in the embodiments of this application.

According to a seventh aspect, a computer program/program product is provided. The computer program/program product is stored in a storage medium, and the computer program/program product is executed by at least one processor to implement the steps of the preamble sending method provided in the embodiments of this application.

In the embodiments of this application, a terminal measures a first signal to obtain a target measurement result, where the target measurement result includes a sensing measurement result; and the terminal sends a preamble based on the target measurement result. In this way, because the preamble is sent based on the sensing measurement result, the terminal that sends the preamble can better meet a sensing requirement, so that sensing performance is improved.

### BRIEF DESCRIPTION OF DRAWINGS

FIG. 1 is a block diagram of a wireless communication system applicable to an embodiment of this application;

FIG. 2 is a schematic diagram of a scenario of sensing measurement according to an embodiment of this application;

FIG. 3 is a flowchart of a preamble sending method according to an embodiment of this application;

FIG. 4 is a schematic diagram of SNR calculation according to an embodiment of this application;

FIG. 5 is a structural diagram of a preamble sending apparatus according to an embodiment of this application;

FIG. 6 is a structural diagram of a communication device according to an embodiment of this application; and

FIG. 7 is a structural diagram of a terminal according to an embodiment of this application.

### DETAILED DESCRIPTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of a same category rather than limiting a quantity of objects. For example, a first object may be one object or a plurality of objects. In addition, in the specification and claims, “and/or” represents at least one of connected objects, and the character “/” generally represents an “or” relationship between associated objects.

It should be noted that, a technology described in embodiments of this application is not limited to a Long Term Evolution (LTE)/LTE-advanced (LTE-A) system, and may be further applied to other wireless communication systems, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. The terms “system” and “network” are often used interchangeably in the embodiments of this application. A described technology may be used for the systems and radio technologies described above, as well as other systems and radio technologies. A New Radio (NR) system is described in the following description for illustrative purposes, and NR terms are used in most of the following description, although these technologies can also be applied to applications other than the NR system application, such as a 6th Generation (6G) communication system.

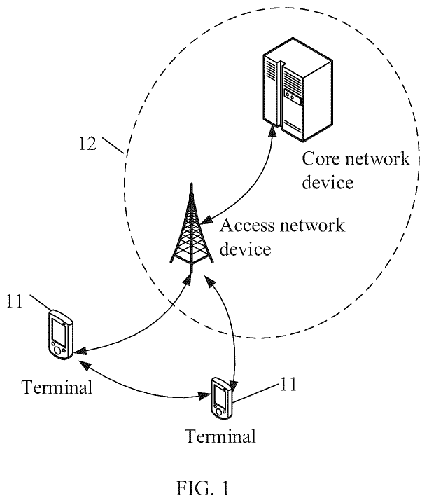

FIG. 1 is a block diagram of a wireless communication system applicable to an embodiment of this application. The wireless communication system includes a terminal 11 and a network-side device 12. The terminal 11 may be a terminal-side device such as a mobile phone, a tablet personal computer, a laptop computer that is referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a road side unit (RSU), a smart home (a home device with a wireless communication function, such as a refrigerator, a television, a laundry machine, or a furniture), a gaming console, a personal computer (PC), a teller machine, or a self-service machine. The wearable device includes: a smart watch, a smart band, a smart headset, smart glasses, smart jewelry (a smart bracelet, a smart wristlet, a smart ring, a smart necklace, a smart anklet, a smart leglet, a smart helmet, a smart joystick, and the like), a smart wristband, smart clothing, and the like. It should be noted that a specific type of the terminal 11 is not limited in this embodiment of this application.

In this embodiment of this application, sidelink (SL) transmission may be performed between terminals 11. In other words, data transmission is directly performed at a physical layer between the terminals 11. SL transmission between the terminals 11 may be broadcast, unicast, multicast, groupcast, or the like. In addition, all terminals that perform SL transmission may be online or offline, or some devices are online and some devices are offline.

The network-side device 12 may include a radio access network device and a core network device. The radio access network device may also be referred to as a Radio Access Network (RAN), a radio access network function, or a radio access network unit. The radio access network device may include a base station, a Wireless Local Area Network (WLAN) access point, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service

Set (ESS), a home NodeB, a home evolved NodeB, a Transmitting Receiving Point (TRP), a small cell, or another appropriate term in the field. Provided that same technical effects are achieved, the base station is not limited to a specific technical term. It should be noted that in the embodiments of this application, only a base station in an NR system is used as an example for description, but a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), Unified Data Repository (UDR), a Home Subscriber Server (HSS), a Centralized network configuration (CNC), a Network Repository Function (NRF), a Network Exposure Function (NEF), a local NEF (Local NEF or L-NEF), a Binding Support Function (BSF), an Application Function (AF), a Network Data Analytics Function (NWDAF), a Location Management Function (LMF), or the like.

In this embodiment of this application, the network-side device and the terminal may have a sensing capability, and by sending and receiving a wireless signal, the network-side device and the terminal can sense information such as a direction, a distance, and a speed of a target object, or detect, track, identify, and image a target object, an event, an environment, or the like. Some sensing functions and application scenarios are shown in Table 1.

TABLE 1

| Communication | | |
|---|---|---|
| sensing category | Sensing function | Application scenario |
| Macro | Weather, air quality, | Meteorology, agriculture, |
| sensing type | and the like | and life services |
| | Traffic flow | Smart city, smart |
| | (intersections) and | transportation, and |
| | crowd flow (subway | commercial services |
| | entrances) | |
| | Target tracking, distance | Many application |
| | measurement, speed | scenarios of a |
| | measurement, | conventional radar |
| | outlining, and | |
| | the like | |
| | Environment | Intelligent driving |
| | reconstruction | and navigation |
| | | (automobiles/unmanned |
| | | aerial vehicles), |
| | | smart city (three- |
| | | dimensional (3D) |
| | | maps), network |
| | | planning, and network |
| | | optimization |
| Granular | Action, posture, | Smart interaction of |
| sensing type | and expression | smartphones, games, |
| | recognition | and smart home |
| | Heartbeat, breathing, | Health and medical care |
| | and the like | |
| | Imaging, material | Security inspection, |
| | detection, component | industry, biological |
| | analysis, and the | medicine, and the like |
| | like | |

It should be noted that the sensing category shown in the foregoing Table 1 is merely an example for description, and a sensing measurement category is not limited in this embodiment of this application.

In addition, this embodiment of this application may be applied to an integrated communication and sensing scenario. Integrated communication and sensing refers to the design of implementing integration of communication and sensing functions through spectrum sharing and hardware sharing in a same system. While transferring information, the system is also capable of sensing information such as a direction, a distance, and a speed, and detecting, tracking, and identifying a target device or event. A communication system and a sensing system cooperate with each other, to improve overall performance and bring better service experience.

For example, integration of communication and radar is a typical integrated communication and sensing application, and fusion of a communication system and a radar system can bring many advantages, such as reducing costs, reducing a size, reducing power consumption, improving spectrum efficiency, and reducing mutual interference, thereby improving overall system performance.

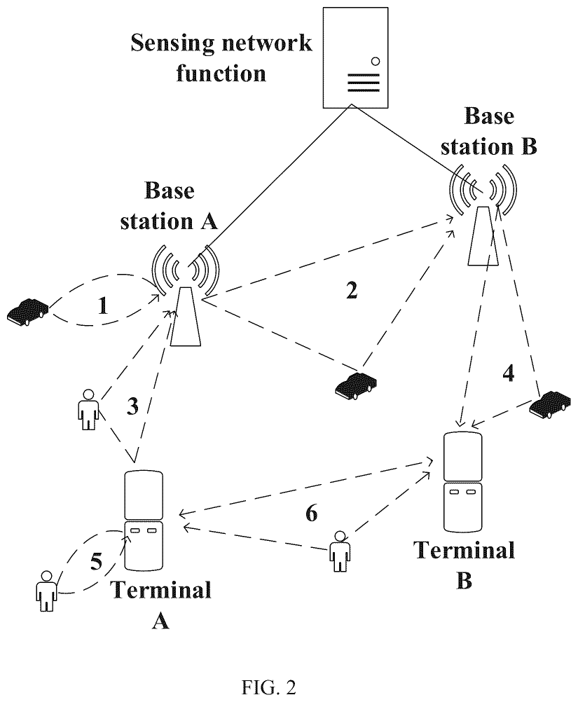

In this embodiment of this application, based on different sensing signal sending nodes and receiving nodes, six types of sensing links shown in FIG. 2 are included, which constitute no limitations. It should be noted that each type of sensing link in FIG. 2 is described by using one sending node and one receiving node as an example. In an actual system, different sensing links may be selected based on different sensing requirements. There may be one or more sending nodes and one or more receiving nodes for each type of sensing link, and an actual sensing system may include a plurality of different sensing links. In addition, as an example, people and vehicles are used as sensing targets in FIG. 2, and it is assumed that none of the people and the vehicles carries or is mounted with a signal receiving/sending device. Sensing targets in an actual scenario are more abundant.

Sensing link 1: Sensing in which a base station performs sending and receiving. In this manner, the base station sends a sensing signal, and obtains a sensing result by receiving an echo of the sensing signal.

Sensing link 2: Air-interface sensing between base stations. In this manner, a base station 2 receives a sensing signal sent by a base station 1, and obtains a sensing result.

Sensing link 3: Uplink air-interface sensing. In this manner, a base station receives a sensing signal sent by a terminal, and obtains a sensing result.

Sensing link 4: Downlink air-interface sensing. In this manner, a terminal receives a sensing signal sent by a base station, and obtains a sensing result.

Sensing link 5: Sensing in which a terminal performs sending and receiving. In this manner, the terminal sends a sensing signal, and obtains a sensing result by receiving an echo of the sensing signal.

Sensing link 6: Sidelink sensing between terminals. For example, a terminal 2 receives a sensing signal sent by a terminal 1, and obtains a sensing result, or a terminal 1 receives a sensing signal sent by a terminal 2, and obtains a sensing result.

With reference to the accompanying drawings, the following describes, in detail by using some embodiments and application scenarios thereof, a preamble sending method, a terminal, and a storage medium that are provided in the embodiments of this application.

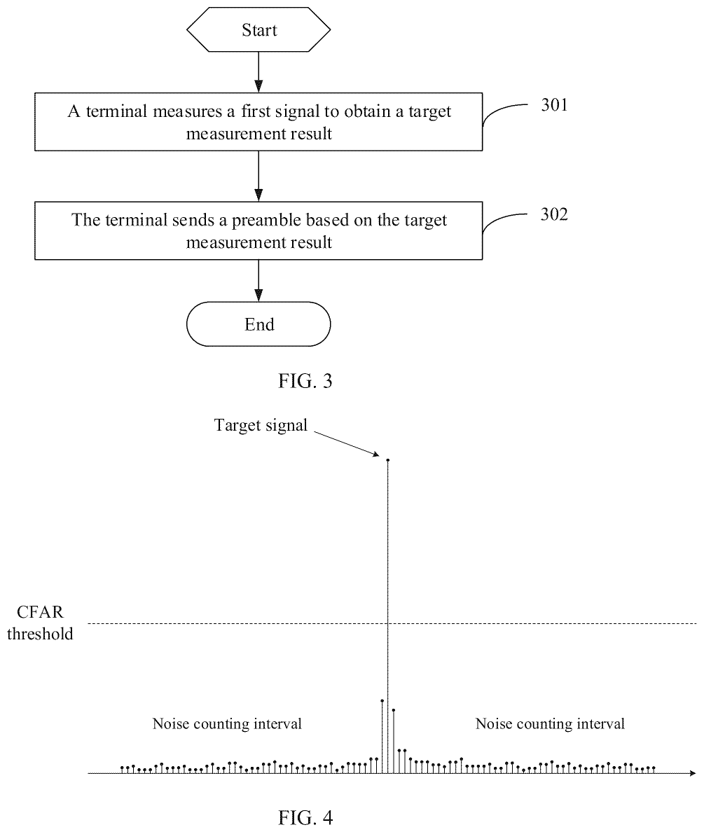

Referring to FIG. 3, FIG. 3 is a flowchart of a preamble sending method according to an embodiment of this application. As shown in FIG. 3, the preamble sending method includes the following steps:

Step 301: A terminal measures a first signal to obtain a target measurement result, where the target measurement result includes a sensing measurement result.

That the terminal measures the first signal may be as follows: The terminal measures one or more first signals. When the terminal measures a plurality of first signals, the plurality of first signals may include signals of a same type or different types. For example, some first signals are signals sent by a network-side device, some first signals may be first signals sent by another terminal, and some first signals may be signals sent and received by the foregoing terminal.

For example, the terminal measures a plurality of synchronization signal and PBCH block (SSB) signals or resources of a plurality of Channel State Information-Reference Signal (CSI-RS).

The sensing measurement result may also be referred to as link sensing performance.

Step 302: The terminal sends a preamble based on the target measurement result.

That the terminal sends a preamble based on the target measurement result may be: sending the preamble in a case that the sensing measurement result meets a preset condition. In some embodiments, that the terminal sends a preamble based on the target measurement result may be: sending a preamble that matches the target measurement result, for example, selecting, from a pre-obtained preamble set, the preamble that matches the target measurement result, and sending the preamble.

In an implementation, the preamble may be a pilot, a reference signal, or the like.

In this embodiment of this application, the preamble may be sent based on the sensing measurement result by using the foregoing steps, so that the terminal that sends the preamble can better meet a sensing requirement, and sensing performance is improved.

In an implementation, the target measurement result further includes a communication measurement result.

In this way, the preamble may be sent based on the sensing measurement result and the communication measurement result, and the preamble may be sent by comprehensively taking communication performance and sensing performance into consideration, to improve access performance of the terminal.

In an implementation, the sending a preamble based on the target measurement result includes:
the terminal sends the preamble in a case that the target measurement result meets a preset condition.

That the target measurement result meets a preset condition includes: the sensing measurement result meets a first preset condition.

In a case that the target measurement result further includes a communication measurement result, that the target measurement result meets a preset condition includes at least one of the following:
the sensing measurement result meets the first preset condition; or
the communication measurement result meets a second preset condition.

The first preset condition and the second preset condition may be defined in a protocol, or may be configured by the network-side device.

That the target measurement result meets a preset condition may be that sensing measurement results of one or more first signals meet the first preset condition. In some embodiments, that the target measurement result meets a preset condition may be that communication measurement results of one or more first signals meet the second preset condition. In some embodiments, that the target measurement result meets a preset condition may be: sensing measurement results of one or more first signals meet the second preset condition, and the communication measurement results of the one or more first signals meet the second preset condition.

That the sensing measurement result meets the first preset condition may be:
the sensing measurement result is higher than a preset threshold corresponding to the sensing measurement result, or the sensing measurement result falls within a preset range corresponding to the sensing measurement result. That the communication measurement result meets the second preset condition may be: the communication measurement result is higher than a preset threshold corresponding to the communication measurement result, or the communication measurement result falls within a preset range corresponding to the communication measurement result.

It should be noted that, in a case that the terminal measures a plurality of first signals, measurement results of some or all of the first signals may meet the preset condition.

In this implementation, the terminal may send the preamble in a case that at least one of the sensing measurement result or the communication measurement result meets the preset condition, to avoid a case in which a measurement result does not meet a requirement when the terminal sends the preamble, thereby improving performance of the terminal, for example, improving sensing performance.

It should be noted that, in this embodiment of this application, one corresponding sensing measurement result may be determined for each first signal, or one sensing measurement result may be obtained for a plurality of first signals. In other words, the first signal and the sensing measurement result may be in a one-to-one correspondence, or may be in a many-to-one relationship. It should be noted that the plurality of first signals herein may be some or all of the first signals measured in step 301. For example, in step 301, N first signals are measured. In some implementations, N sensing measurement results may be obtained. In some other implementations, M measurement results may be obtained. M is an integer greater than or equal to 1 and less than N. Similarly, the first signal and the communication measurement result may be in a one-to-one correspondence, or may be in a many-to-one relationship.

In an implementation, the first signal may be a signal that does not include transmission information, and the signal that does not include transmission information may be a synchronization signal or a reference signal.

For example, the first signal may include:
a Synchronization Signal and PBCH block (SSB) signal, a Channel State Information-Reference Signal (CSI-RS), a Demodulation Reference Signal (DMRS), a Sounding Reference Signal (SRS), a Positioning Reference Signal (PRS), a Phase Tracking Reference Signal (PTRS), and the like.

In some embodiments, the first signal may be a single-frequency Continuous Wave (CW), a Frequency Modulated CW (FMCW), an ultra-wideband Gaussian pulse, and the like commonly used by a radar.

In some embodiments, the first signal may be a newly designed dedicated signal, for example, a signal that has a good correlation characteristic and a low peak-to-average power ratio; or a newly designed integrated communication and sensing signal, where the signal carries specific information and has relatively good sensing performance. For example, the first signal is a signal obtained by splicing, combining, or superimposing at least one dedicated sensing signal/reference signal and at least one communication signal in time domain and/or frequency domain.

In an implementation, in a case that the target measurement result includes the sensing measurement result and the communication measurement result,
the target measurement result includes the sensing measurement result and the communication measurement result that are obtained by measuring a same first signal; or
the target measurement result includes: the sensing measurement result obtained by measuring a first signal set, and the communication measurement result obtained by measuring a second signal set, where the first signal set and the second signal set include different first signals.

The sensing measurement result and the communication measurement result that are obtained by measuring the same first signal may be a sensing measurement result obtained by performing measurement in terms of sensing measurement results on one or more first signals and a communication measurement result obtained by performing measurement in terms of communication measurement results on the one or more first signals. In other words, each first signal is measured to obtain a corresponding sensing measurement result and a corresponding communication measurement result. In this way, the preamble may be sent in a case that sensing measurement results and communication measurement results of some or all first signals meet the preset condition.

The sensing measurement result obtained by measuring the first signal set and the communication measurement result obtained by measuring the second signal set may be: the sensing measurement result is obtained by measuring a part of the first signals, and the communication measurement result is obtained by measuring the other part of the first signals. In this way, the preamble may be sent in a case that sensing measurement results of some first signals meet the preset condition and communication measurement results of some first signals meet the preset condition.

In addition, the first signal set and the second signal set may include first signals of a same type or different types.

In an implementation, before the terminal measures the first signal to obtain the target measurement result, the method further includes:
the terminal receives first indication information, where the first indication information is used to indicate at least one of the following:
configuration information of the first signal;
a type of the sensing measurement result;
a first preset condition corresponding to the sensing measurement result; or
a measurement requirement.

The configuration information includes at least one of the following:
a waveform type, a subcarrier spacing, a guard interval, bandwidth, burst duration, a time domain spacing, transmit power, a signal format, a signal direction, a time resource, a frequency domain resource, a Quasi co-location (QCL) relationship, or antenna configuration information.

The waveform type may be a type such as Orthogonal frequency division multiplex (OFDM), Single-carrier Frequency-Division Multiple Access (SC-FDMA), Orthogonal Time Frequency Space (OTFS), Frequency Modulated Continuous Wave (FMCW), or a pulse signal.

The subcarrier spacing may be a subcarrier spacing of an OFDM system, for example, 30 KHz.

The guard interval may be a time interval from a moment at which sending of a signal ends to a moment at which a latest echo signal of the signal is received. This parameter is proportional to a maximum sensing distance. For example, this parameter may be obtained through calculation of 2dₘₐₓ/c, where dₘₐₓ is the maximum sensing distance (belonging to a sensing requirement). For example, for a self-sent and received sensing signal, dₘₐₓ represents a maximum distance between a signal transmitting and receiving point of a sensing signal and a signal transmitting point. In some cases, an OFDM signal cyclic prefix (CP) may function as a minimum guard interval.

The bandwidth may be inversely proportional to distance resolution, and may be obtained through calculation of c/(2Δd), where Ad is the distance resolution (belonging to a sensing requirement), and c is the speed of light.

The Burst duration may be inversely proportional to rate resolution (belonging to a sensing requirement). This parameter is a time span of a sensing signal, and is mainly used to calculate a Doppler frequency offset. This parameter may be obtained through calculation of c/(2f_{c}Δv), where Av is speed resolution, and fc is a carrier frequency of the sensing signal.

The time domain spacing may be obtained through calculation of c/(2f_{c}v_{range}), where v_{range} is a maximum speed minus a minimum speed (belonging to a sensing requirement), and this parameter is a time interval between two adjacent sensing signals.

One value may be taken every 2 dBm from −20 dBm to 23 dBm as the transmit power.

The signal format may be information such as an SRS, a DMRS, or a PRS, or another predefined signal, and a related sequence format.

The signal direction may be direction or beam information of the first signal.

The time resource may be an index of a slot in which the first signal is located or a symbol index of the slot. There are two types of time resources: One is a one-time time resource, for example, one omnidirectional sensing signal is sent on one symbol. The other is non-one-time time resource, such as a plurality of groups of periodic time resources or non-continuous time resources (which may include start time and end time), where sensing signals in a same direction are sent on each group of periodic time resources, and beam directions of periodic time resources in different groups are different.

The frequency resource may include a center frequency, bandwidth, a Resource block (RB), a subcarrier, a reference point (Point A), a start bandwidth location, and the like of the first signal.

The QCL relationship may be QCL between a resource of the first signal and an SSB. For example, the first signal includes a plurality of resources, each resource is in

QCL with one SSB, and the QCL includes a type (Type) A, a type B, a type C, or a type D.

The antenna configuration information may be antenna configuration information of a device (for example, the network-side device or the terminal) that sends or receives the first signal, and may include at least one of the following:
an antenna array element ID or an antenna port ID used to send and/or receive the first signal;
an antenna panel ID+an antenna array element ID used to send and/or receive the first signal;
location information, relative to a local reference point on an antenna array, of an antenna array element used to send and/or receive a sensing signal, which, for example, may be represented by Cartesian coordinates (x, y, z) or spherical coordinates (ρ, φ, θ);
location information, relative to a local reference point on an antenna array, of a panel used to send and/or receive a sensing signal, which, for example, may be represented by using Cartesian coordinates (x, y, z) or spherical coordinates (ρ, φ, θ), and location information, relative to a unified reference point (for example, a center point of the panel) of the selected panel, of antenna array elements in these panels that are used to send a sensing signal, which, for example, may be represented by using Cartesian coordinates (x, y, z) or spherical coordinates (ρ, φ, θ);
bitmap information of an antenna array element, for example, this bitmap indicates, by using “1”, that an array element is selected to send and/or receive a sensing signal, and indicates, by using “0”, that the array element is not selected (or vice versa); or
bitmap information of an array panel, for example, this bitmap indicates, by using “1”, that the panel is selected to send and/or receive a sensing signal, and indicates, by using “0”, that the panel is not selected (or vice versa); and bitmap information of array elements in these selected panels.

The type of the sensing measurement result may include at least one of the following:
sensing component power of the first signal, a sensing signal-to-noise ratio (SNR), a sensing signal-to-interference-plus-noise ratio (SINR), whether a sensing target exists, a quantity of sensing targets, a sensing Radar Cross Section (RCS), sensing spectrum information, a sensing delay, a sensing distance, sensing Doppler, a sensing speed, or sensing angle information.

The first preset condition corresponding to the sensing measurement result may be a threshold condition corresponding to the sensing measurement result, for example, a threshold condition corresponding to each of the signal component power, the sensing SNR, the sensing SINR, the quantity of sensing targets, the sensing RCS, the sensing spectrum information, the sensing delay, the sensing distance, the sensing Doppler, the sensing speed, or the sensing angle information.

The measurement requirement may be used to instruct the terminal that obtains, by measuring the first signal, the sensing measurement result meeting the preset condition to send the preamble. For example, the measurement requirement is a sensing requirement, and the sensing requirement may be used to instruct a terminal that obtains, by measuring the first signal, sensing link performance meeting a sensing condition to send the preamble.

In the foregoing implementation, because the first indication information is received before the first signal is measured, measurement may be performed and the preamble may be sent based on the first indication information, to improve accuracy of measuring and sending the preamble by the terminal.

In an implementation, before the sending a preamble, the method further includes:
determining a preamble sending parameter based on at least one of the sensing measurement result or the communication measurement result, where the communication measurement result is the communication measurement result included in the target measurement result.

It should be noted that, in a case that the target measurement result does not include the communication measurement result, in this implementation, the preamble sending parameter may be determined based on the sensing measurement result, and in a case that target measurement result includes the communication measurement result, in this implementation, the preamble sending parameter may be determined based on at least one of the sensing measurement result or the communication measurement result.

The preamble sending parameter may include at least one of the following:
a time domain resource, a frequency domain resource, or a preamble sequence parameter.

The time domain resource is a time domain resource location for sending the preamble, the frequency domain resource is a frequency domain resource location for sending the preamble, and the preamble sequence parameter may be a preamble sequence format, a preamble sequence index, or the like.

In some implementations, the preamble sending parameter includes at least one of the following:
a preamble sending parameter corresponding to at least one first signal in a third signal set, where the third signal set includes a first signal whose sensing measurement result meets the first preset condition and whose communication measurement result meets the second preset condition;
a preamble sending parameter corresponding to a fourth signal set, where the fourth signal set includes at least one first signal in a fifth signal set and at least one first signal in a sixth signal set; or
a preamble sending parameter corresponding to at least one first signal in the fifth signal set and a preamble sending parameter corresponding to at least one first signal in the sixth signal set; where
the fifth signal set includes a first signal whose sensing measurement result meets the first preset condition, and the sixth signal set includes a first signal whose communication measurement result meets the second preset condition.

A correspondence or a mapping relationship between the first signal and the preamble sending parameter is defined in a protocol and/or is configured by a base station for the terminal.

In this implementation, each first signal corresponds to a group of preamble sending parameters. For example, a preamble sending parameter corresponding to each first signal includes at least one of the following:
a sending parameter configured by a network side or a sending parameter defined in a protocol.

In addition, preamble sending parameters corresponding to different first signals may be different, or preamble sending parameters corresponding to some first signals are the same.

A sensing measurement result of each first signal in the third signal set meets the first preset condition, and a communication measurement result meets the second preset condition. The preamble sending parameter corresponding to the at least one first signal in the third signal set may be determined in the following manner: selecting the at least one first signal from the third signal set, and determining the preamble sending parameter corresponding to the at least one first signal.

A sensing measurement result of each first signal in the fifth signal set meets the first preset condition, and a communication measurement result of each first signal in the sixth signal set meets the second preset condition.

The preamble sending parameter corresponding to the fourth signal set may be determined in the following manner: selecting at least one first signal from the fifth signal set, selecting at least one first signal from the sixth signal set, and then determining a preamble sending parameter corresponding to the at least one first signal selected from the fifth signal set and a preamble sending parameter corresponding to the at least one first signal selected from the sixth signal set. The preamble sending parameter corresponding to the at least one first signal selected from the fifth signal set and the preamble sending parameter corresponding to the at least one first signal selected from the sixth signal set are the same. In other words, finally determined preamble sending parameters respectively correspond to the at least one first signal in the fifth signal set and the at least one first signal in the sixth signal set, so that the finally determined preamble sending parameters correspond to both the first signal whose sensing measurement result meets the first preset condition and the first signal whose communication measurement result meets the second preset condition. In this way, performance of sending the preamble is improved.

That the preamble sending parameter includes the preamble sending parameter corresponding to the at least one first signal in the fifth signal set and the preamble sending parameter corresponding to the at least one first signal in the sixth signal set may be understood as follows: the preamble sending parameter includes two groups of preamble sending parameters.

In some implementations, in a case that the preamble sending parameter includes the preamble sending parameter corresponding to the at least one first signal in the fifth signal set and the preamble sending parameter corresponding to the at least one first signal in the sixth signal set, the sending a preamble includes:
sending the preamble based on the preamble sending parameter corresponding to the at least one first signal in the fifth signal set; and
sending the preamble based on the preamble sending parameter corresponding to the at least one first signal in the sixth signal set.

In this implementation, the preamble may be sent twice, for example, two different preambles are sent.

In some implementations, in a case that the preamble sending parameter includes the preamble sending parameter corresponding to the at least one first signal in the third signal set or the preamble sending parameter corresponding to the fourth signal set, the terminal sends one preamble, and uplink transmit power of the preamble is determined based on Reference Signal Received Power (RSRP) of the first signal whose communication measurement result meets the second preset condition.

Determining the uplink transmit power based on the RSRP may be: determining the uplink transmit power based on a calculation formula or a mapping relationship between the RSRP and the uplink transmit power that is agreed upon in a protocol.

In this implementation, the uplink transmit power of the preamble may be determined based on RSRP of the first signal whose communication measurement result meets the second preset condition, so that the uplink transmit power of the preamble matches the RSRP of the first signal whose communication measurement result meets the second preset condition, thereby improving transmission reliability of the preamble.

In some implementations, in a case that the preamble sending parameter includes the preamble sending parameter corresponding to the at least one first signal in the fifth signal set and the preamble sending parameter corresponding to the at least one first signal in the sixth signal set, the terminal sends two preambles, where uplink transmit power of one preamble is determined based on RSRP of the first signal whose communication measurement result meets the second preset condition, and uplink transmit power of the other preamble is determined based on RSRP of the first signal whose sensing measurement result meets the first preset condition.

In this implementation, uplink transmit power of one preamble may be determined based on the RSRP of the first signal whose communication measurement result meets the second preset condition, and uplink transmit power of the other preamble may be determined based on the RSRP of the first signal whose sensing measurement result meets the first preset condition, so that the two preambles are separately sent at different power, thereby improving a success rate of access by the terminal.

In an implementation, the sending a preamble includes:
sending a first message, where the first message includes the preamble, and further includes at least one of the following:
a sensing measurement amount for the first signal; or
the sensing measurement result.

The sensing measurement amount may include the following four types:
a first-level measurement amount (a received signal/original channel information), including a received signal/channel response complex result, an amplitude/phase, an I-channel/Q-channel and operation results thereof (operations include addition, subtraction, multiplication, and division, matrix addition, subtraction, and multiplication, matrix transposition, a trigonometric operation, a square root operation, a power operation, and the like, along with a threshold detection result, a maximum/minimum extraction result, and the like of the foregoing operation result; and the operations further include Fast Fourier Transform (FFT)/Inverse Fast Fourier Transform (IFFT), Discrete Fourier Transform (DFT)/Inverse Discrete Fourier Transform (IDFT), 2D-FFT, 3D-FFT, matched filtering, an autocorrelation operation, wavelet transform, digital filtering, and the like, along with a threshold detection result, a maximum/minimum extraction result, and the like of the foregoing operation result);
a second-level measurement amount (a basic measurement amount), including a delay, Doppler, an angle, strength, and a multidimensional combination thereof;
a third-level measurement amount (a basic attribute/state), including a distance, a speed, an orientation, a spatial location, and an acceleration; and
a fourth-level measurement amount (an advanced attribute/state), including: whether a target exists, a track, an action, an expression, a vital sign, a quantity, an imaging result, weather, air quality, a shape, a material, and a component.

In some implementations, the sensing measurement amount may further include corresponding label information, for example, include at least one of the following:
sensing signal identification information;
sensing measurement configuration identification information;
sensing service information (for example, a sensing service ID);
a data subscription ID;
a measurement amount usage (communication, sensing, and communication and sensing);
time information;
information about a sensing node (for example, a UE ID, a node location, and a device orientation);
information about a sensing link (for example, a sequence number of the sensing link and identifiers of a transmitting node and a receiving node);
description information of the measurement amount, where a format is, for example, an amplitude, a phase, or a complex number, and resource information is, for example, an antenna/antenna pair/antenna group, a Physical Resource Block (PRB), and a symbol; or
indicator information of the measurement amount, for example, a Signal to Noise Ratio (SNR) or a sensing SNR.

That the first message includes the sensing measurement result may be: in a two-step random access procedure, the terminal sends the preamble, and sends the sensing measurement result of the first signal, the sensing measurement amount for the first signal, or the sensing measurement result and the sensing measurement amount through a Physical Uplink Shared Channel (PUSCH) of a MSG A (message A).

In this implementation, because the sensing measurement amount and the sensing measurement result are reported, the network-side device may determine the sensing measurement amount corresponding to the sensing measurement result, to more accurately understand sensing link performance of the terminal.

In an implementation, the sensing measurement result includes at least one of the following:
sensing component power of the first signal;
a sensing signal-to-noise ratio (SNR);
a sensing signal-to-interference-plus-noise ratio (SINR);
whether a sensing target exists;
a quantity of sensing targets;
a sensing radar cross-section (RCS);
sensing spectrum information;
a sensing delay;
a sensing distance;
sensing Doppler;
a sensing speed; or
sensing angle information.

The sensing component power of the first signal may be power information of a signal component associated with the sensing target, for example, power information of a sensing path. In some embodiments, power of a signal component that is in the first signal and that is significantly affected by the sensing target is received, which may include at least one of the following:
a power value calculated by using an amplitude corresponding to a sample value point with a maximum amplitude in a frequency domain channel response of the received first signal as a target amplitude, or a power value calculated by using amplitudes corresponding to a plurality of sample value points with a maximum amplitude as target amplitudes; or a power value calculated by using an amplitude of a sample value point corresponding to a specified subcarrier (SC) or Physical Resource Block (PRB) as a target amplitude, or a power value calculated by using amplitudes of sample value points corresponding to a plurality of specified SCs or PRBs as target amplitudes;
a power value calculated by using an amplitude corresponding to a sample value point with a maximum amplitude in an inverse Fourier transform (IFFT) result (a delay domain) of a frequency domain channel response of the received first signal as a target amplitude, or a power value calculated by using amplitudes corresponding to a plurality of sample value points with a maximum amplitude as target amplitudes; or a power value calculated by using an amplitude corresponding to a sample value point with a maximum amplitude in a specific delay range as a target amplitude, or a power value calculated by using amplitudes corresponding to a plurality of sample value points with a maximum amplitude as target amplitudes;
a power value calculated by using an amplitude corresponding to a sample value point with a maximum amplitude in a Fourier transform (FFT) result (a Doppler domain) of a frequency domain channel response of the received first signal as a target amplitude, or a power value calculated by using amplitudes corresponding to a plurality of sample value points with a maximum amplitude as target amplitudes; or a power value calculated by using an amplitude corresponding to a sample value point with a maximum amplitude in a specific Doppler range as a target amplitude, or a power value calculated by using amplitudes corresponding to a plurality of sample value points with a maximum amplitude as target amplitudes; or
a power value calculated by using an amplitude corresponding to a sample value point with a maximum amplitude in a two-dimensional Fourier transform result, that is, a delay-Doppler domain result, of a channel response of the received first signal as a target amplitude, or a power value calculated by using amplitudes corresponding to a plurality of sample value points with a maximum amplitude as target amplitudes; or a power value calculated by using an amplitude corresponding to a sample value point with a maximum amplitude in a specific delay-Doppler range as a target amplitude, or a power value calculated by using amplitudes corresponding to a plurality of sample value points with a maximum amplitude as target amplitudes.

It should be noted that the maximum amplitude may be or exceeds a specific threshold, and the specific threshold may be indicated by the network-side device, or may be obtained by the terminal through calculation based on noise power and/or interference power. The specific delay/Doppler range is related to the sensing requirement, and may be indicated by the network-side device, or may be obtained by the terminal based on the sensing requirement.

The sensing SNR may be a ratio of the sensing component power of the first signal to the noise power, and the sensing SINR may be a ratio of the sensing component power of the first signal to a sum of the noise power and the interference power.

Radar detection is used as an example. The sensing component power of the first signal is echo power, and a method for obtaining power of an echo signal may be at least one of the following options:

Manner 1: Constant False Alarm Rate Detection (CFAR) is performed based on a one-dimensional delay map obtained through fast-time dimensional FFT processing of the echo signal, and a sample value point with a maximum amplitude whose CFAR exceeds a threshold is used as a target sample value point, and the amplitude thereof is used as a target signal amplitude, to calculate the power of the echo signal, as shown in FIG. 4.

Manner 2: CFAR is performed based on a one-dimensional Doppler map obtained through slow-time dimensional FFT processing of the echo signal, and a sample value point with a maximum amplitude whose CFAR exceeds a threshold is used as a target sample value point, and the amplitude thereof is used as a target signal amplitude, to calculate the power of the echo signal, also as shown in FIG. 4.

Manner 3: CFAR is performed based on a two-dimensional Doppler map obtained through 2D-FFT processing of the echo signal, and a sample value point with a maximum amplitude whose CFAR exceeds a threshold is used as a target sample value point, and the amplitude thereof is used as a target signal amplitude, to calculate the power of the echo signal.

Manner 4: CFAR is performed based on a three-dimensional delay-Doppler-angle map obtained through 3D-FFT processing of the echo signal, and a sample value point with a maximum amplitude whose CFAR exceeds a threshold is used as a target sample value point, and the amplitude thereof is used as a target signal amplitude, to calculate the power of the echo signal.

In addition to the foregoing method in which the sample value point with the maximum amplitude whose CFAR exceeds the threshold is used as the target sample value point, a method for determining a signal amplitude may also be as follows: the sample value point with the maximum amplitude whose CFAR exceeds the threshold and an average value of several nearest sample value points exceeding the threshold are used as a target signal amplitude to calculate the power of the echo signal.

The foregoing method for obtaining the sensing SNR and the sensing SINR may include at least one of the following manners:

Manner 1: CFAR is performed based on a one-dimensional delay map obtained through fast-time dimensional FFT processing of the echo signal, a sample value point with a maximum amplitude whose CFAR exceeds a threshold is used as a target sample value point, the amplitude thereof is used as a target signal amplitude, and all sample value points other than ±ε sample value points from a location of the target sample value point in the one-dimensional map are used as interference/noise sample value points, and an average interference/amplitude thereof is counted as an interference/noise signal amplitude, as shown in FIG. 4. Finally, an SNR/SINR is calculated by using the target signal amplitude and the interference/noise signal amplitude. ε is a constant.

Manner 2: CFAR is performed based on a one-dimensional Doppler map obtained through slow-time dimensional FFT processing of the echo signal, a sample value point with a maximum amplitude whose CFAR exceeds a threshold is used as a target sample value point, the amplitude thereof is used as a target signal amplitude, and all sample value points other than ±η sample value points from a location of the target sample value point in the one-dimensional map are used as interference/noise sample value points, and an average amplitude thereof is counted as an interference/noise signal amplitude. Finally, an SNR/SINR is calculated by using the target signal amplitude and the interference/noise signal amplitude. η is a constant.

Manner 3: CFAR is performed based on a two-dimensional delay-Doppler map obtained through 2D-FFT processing of the echo signal, a sample value point with a maximum amplitude whose CFAR exceeds a threshold is used as a target sample value point, the amplitude thereof is used as a target signal amplitude, and all sample value points other than ±ε (a fast-time dimension) and ±η (a slow-time dimension) sample value points from the target sample value point in the two-dimensional map are used as interference/noise sample value points, and an average amplitude thereof is counted as an interference/noise signal amplitude. Finally, an SNR/SINR is calculated by using the target signal amplitude and the interference/noise signal amplitude.

Manner 4: CFAR is performed based on a three-dimensional delay-Doppler-angle map obtained through 3D-FFT processing of the echo signal, a sample value point with a maximum amplitude whose CFAR exceeds a threshold is used as a target sample value point, the amplitude thereof is used as a target signal amplitude, and all sample value points other than ±ε (a fast-time dimension), ±η (a slow-time dimension), and ±δ (an angle dimension) sample value points from the target sample value point in the three-dimensional map are used as interference/noise sample value points, and an average amplitude thereof is counted as an interference/noise signal amplitude. Finally, an SNR/SINR is calculated by using the target signal amplitude and the interference/noise signal amplitude. δ is a constant.

Manner 5: In addition to the foregoing method in which the sample value point with the maximum amplitude whose CFAR exceeds the threshold is used as the target sample value point, a method for determining the target signal amplitude may also be as follows: an average value of the sample value point with the maximum amplitude whose CFAR exceeds the threshold and several nearest sample value points exceeding the threshold is used as the target signal amplitude.

In addition, a method for determining the interference/noise sample value point may be: performing further screening based on the foregoing determined interference/noise sample value point. A screening method is as follows: For the one-dimensional delay map, several sample value points near a delay of 0 are removed, and remaining interference/noise sample points are used as noise sample value points; or for the one-dimensional Doppler map, several sample value points near Doppler of 0 are removed, and remaining interference/noise sample value points are used as interference/noise sample value points; or for the two-dimensional delay-Doppler map, several points near a delay of 0 and interference/noise sample points in a strip range formed by all Doppler ranges are removed, and remaining noise sample value points are used as interference/noise sample value points; or for the three-dimensional delay-Doppler-angle map, several points near a delay of 0 and interference/noise sample value points in a slice range formed by all Doppler ranges and all angle ranges are removed, and remaining interference/noise sample points are used as interference/noise sample points.

Whether the sensing target exists may be: performing sensing to determine whether the sensing target exists, or performing sensing to determine whether a target within a preset speed/Doppler range exists, or performing sensing to determine whether a target within a preset distance/delay range exists.

The quantity of sensing targets may be a quantity of targets in a preset sensing speed/Doppler range or a quantity of targets in a preset sensing distance/delay range.

The preset range may be obtained by sensing requirement information.

In some implementations, a manner of determining whether the target exists may be: determining whether a sample value point whose amplitude exceeds a specific threshold exists in a one-dimensional or two-dimensional delay/Doppler map. If the sample value point exists, it is considered that the target is detected. Determining a quantity of existing targets may be: considering a quantity of sample value points whose amplitudes exceed a specific threshold in the one-dimensional or two-dimensional delay/Doppler map as the quantity of targets.

The sensing RCS may be RCS information of a single sensing target, or may be RCS information of a plurality of targets.

The sensing spectrum information may include at least one of the following:
a delay power spectrum, a Doppler power spectrum, a delay/distance-Doppler/speed spectrum, an angle power spectrum, a delay/distance-angle spectrum, a Doppler/speed-angle spectrum, or a delay/distance-Doppler/speed-angle spectrum.

The sensing delay, the sensing distance, the sensing Doppler, the sensing speed, and the sensing angle information may be sensing information of a single sensing target, or may be sensing information of a plurality of targets.

In the foregoing implementation, sending of the preamble may be triggered based on sensing measurement, so that the corresponding first signal for sending the preamble meets the sensing requirement. For example, in a case that the communication measurement result is a communication performance measurement result, the first signal (for example, an SSB) may be selected by comprehensively taking communication performance and sensing performance into consideration, and a target first signal (for example, a target SSB) may be found in a timely manner to meet the sensing requirement.

In some implementations, the first preset condition corresponding to the sensing measurement result includes at least one of the following:
the sensing component power of the first signal meets a first threshold condition;
the sensing SNR meets a second threshold condition;
the sensing SINR meets a third threshold condition;
the sensing target exists;
the quantity of sensing targets meets a fourth threshold condition;
the sensing radar cross-section RCS meets a fifth threshold condition;
the sensing spectrum information meets a sixth threshold condition;
the sensing delay meets a seventh threshold condition;
the sensing distance meets an eighth threshold condition;
the sensing Doppler meets a ninth threshold condition;
the sensing speed meets a tenth threshold condition; or
the sensing angle information meets an eleventh threshold condition.

The first threshold condition to the eleventh threshold condition are configured by a network side or agreed upon in a protocol. In addition, each threshold condition may include one or more thresholds.

That the sensing component power of the first signal meets the first threshold condition may be that signal component power of one first signal meets the first threshold condition, or may be that signal component power of X first signals meets the first threshold condition, where X is configured by the network side, X is an integer greater than 1, and the signal component power is calculated based on the X first signals.

For another example, that the sensing SNR meets the second threshold condition may be that a sensing SNR of one first signal meets the second threshold condition, or may be that sensing SNRs of X first signals meet the second threshold condition, where the sensing SNR is calculated based on the X first signals.

For another example, that the sensing SINR meets the third threshold condition may be that a sensing SINR of one first signal meets the third threshold condition, or may be that sensing SINRs of X first signals meet the third threshold condition, where the sensing SINR is calculated based on the X first signals.

That the quantity of sensing targets meets the fourth threshold condition may be that at least Y targets are detected, where Y is configured by the network side or agreed upon in a protocol.

That the quantity of sensing targets meets the fourth threshold condition may be, In some embodiments, that a manner similar to a bitmap is used, where a location of each bit in the bitmap represents a target, a bit being 1 indicates that the target is detected, a bit being 0 indicates that the target is not detected, and a bitmap corresponding to the fourth threshold condition is configured by the network-side device or agreed upon in a protocol.

That the sensing RCS meets the fifth threshold condition may be that RCS information of a single sensing target meets the fifth threshold condition, or may be that RCS information of a plurality of targets meets the fifth threshold condition.

The sensing spectrum information, the sensing delay, the sensing distance, the sensing Doppler, the sensing speed, and the sensing angle information may be that sensing information of a single sensing target or sensing information of a plurality of targets meets a corresponding threshold condition.

In addition, in this embodiment of this application, a sensing performance evaluation indicator corresponding to sensing link performance may be calculated based on a sensing measurement amount. For example, the sensing performance evaluation indicator may include at least one of the following:
a sensing SNR, that is, a ratio of energy of a sensing signal reflected by a sensing object or a sensing region to energy of a noise signal in an environment and a device;
a sensing SINR, that is, a ratio of energy of a sensing signal reflected by a sensing object or a sensing region to a sum of energy of an interference signal and a noise signal in an environment and a device;
a statistical mean, a standard deviation, or a variance of a plurality of measurement values of a same sensing measurement amount;
a deviation of a predicted value of a sensing measurement amount/sensing result from an actual measurement value, and a statistical mean, a standard deviation, or a variance of the deviation; or
an evaluation indicator of reproducibility in sensing (for example, a sum of Euclidean distances between two sequential sample value points, a wrap path distance in

Dynamic Time Warping (DTW), or another indicator that can reflect similarity between two sequences, including but not limited to a Longest Common Subsequence (LCSS), an Edit Distance on Real Sequences (EDR), an Edit Distance with Real Penalty (ERP), a Hausdorff distance (Hausdorff Distance), a Fréchet distance (Fréchet Distance), a One Way Distance (OWD), a Locality In-between Polylines (LIP), and the like).

In an implementation, the communication measurement result includes at least one of the following:

RSRP, a Received Signal Strength Indication (RSSI), a Precoding matrix indicator (PMI), a Rank indicator (RI), a Channel quality indicator (CQI), a signal-to-noise ratio, a signal-to-interference-plus-noise ratio, a Bit Error Rate (BER), or a Block Error Rate (BLER).

In this implementation, the communication measurement result is a communication link measurement result, or is referred to as communication link performance. Therefore, the preamble can be sent based on the communication link performance.

In addition, the first threshold condition to the eleventh threshold condition may be that sensing measurement results of one or more first signals meet a corresponding threshold condition, which indicates that the sensing link performance meets a communication condition, so that the preamble is sent.

In some implementations, the second preset condition corresponding to the communication measurement result includes at least one of the following:
the RSRP meets a twelfth threshold condition;
the RSSI meets a thirteenth threshold condition;
the PMI meets a fourteenth threshold condition;
the RI meets a fifteenth threshold condition;
the CQI meets a sixteenth threshold condition;
the SNR meets a seventeenth threshold condition;
the SINR meets an eighteenth threshold condition;
the BER meets a nineteenth threshold condition; or
the BLER meets a twentieth threshold condition.

The twelfth threshold condition to the twentieth threshold condition are configured by the network side or agreed upon in a protocol. In addition, each threshold condition may include one or more thresholds.

In addition, the twelfth threshold condition to the twentieth threshold condition may be that communication measurement results of one or more first signals meet a corresponding threshold condition, which indicates that the communication link performance meets a communication condition, so that the preamble is sent.

In an implementation, the sending a preamble includes:
sending a MSG 1, where the MSG 1 includes the preamble; or
sending a MSG A, where the MSG A includes the preamble.

In this implementation, the preamble may be sent in a four-step random access procedure or a two-step random access procedure.

In this embodiment of this application, the preamble may be sent based on the sensing measurement result, so that the terminal that sends the preamble can better meet the sensing requirement, thereby improving sensing performance.

The method provided in the embodiments of this application is described below as an example by using two embodiments.

### Embodiment 1

This embodiment is described by using four-step random access (which may be performed when a downlink sensing requirement arrives) as an example, and includes the following steps:
Step 1: A base station sends first indication information to one or more UEs.

The first indication information is used to indicate at least one of the following:
configuration information or the like of a first signal;
sensing link performance of the first signal;
sensing condition information of the first signal; or
a sensing requirement, where the sensing requirement may be used to instruct UE that obtains, by measuring the first signal (for example, an SSB), sensing link performance meeting a sensing condition to send a preamble to the base station.

In addition, the first indication information may be L1 signaling (for example, a MSG 0) carried on a PDCCH, SIB signaling such as a SIB 1, a MAC CE, RRC signaling, paging, or the like.
Step 2: The UE measures N (N≥1) first signals sent by the base station.
Step 3: The UE determines, based on whether sensing link performance obtained by measuring the first signal meets the sensing condition and/or whether the communication link performance meets a communication condition, whether to send a preamble. In some embodiments:

If sensing link performance of one or more first signals meets the sensing condition and communication link performance of the same first signal meets the communication condition, or sensing link performance of one or more first signals meets the sensing condition and communication link performance of one or more other first signals meets the communication condition, the UE needs to send the preamble. Otherwise, the UE does not need to send the preamble.
Step 4: If the UE determines that the preamble needs to be sent, the UE determines a sending parameter of the preamble (including a time domain resource, a frequency domain resource, a preamble sequence parameter, and the like), which may be as follows:

Method A for determining the sending parameter of the preamble by the UE: determining a target SSB (a type of the first signal) set whose sensing link performance meets the sensing condition and whose communication link performance meets the communication condition; and selecting one or more SSBs from the target SSB set, and determining a sending parameter of a preamble corresponding to the one or more SSBs (if the preamble is sent once, the preamble corresponds to one SSB in the target SSB set whose sensing link performance meets the sensing condition and whose communication link performance meets the communication condition).

Method B for determining the sending parameter of the preamble by the UE: determining a target SSB set whose sensing link performance meets the sensing condition; selecting one or more SSBs (an SSB set X) from the target SSB set; determining a target SSB set whose communication link performance meets the communication condition; selecting one or more SSBs (an SSB set Y) from the target SSB set; and determining a sending parameter of a preamble corresponding to the SSB set X and the SSB set Y, where in this case, the preamble is sent once.

Method C for determining the sending parameter of the preamble by the UE: determining a target SSB set whose sensing link performance meets the sensing condition; selecting one or more SSBs from the target SSB set, and determining a sensing parameter of a preamble 1 corresponding to the one or more SSBs; determining a target SSB set whose communication link performance meets the communication condition; and selecting one or more SSBs from the target SSB set, and determining a sending parameter of a preamble 2 corresponding to the one or more SSBs, where in this case, the preamble is sent twice.

A sending parameter (including a time domain resource, a frequency domain resource, a preamble sequence format, and the like) of a preamble corresponding to one or more SSBs is configured by the base station and/or defined in a protocol.
Step 5: The UE sends one or more preambles to the base station based on sending parameters that are of the one or more preambles and that are determined in the previous step.
a) If the UE sends one preamble, an uplink power control of the preamble may determine uplink power of the preamble based on RSRP of a first signal whose communication link performance meets the communication condition.
b) If the UE sends two preambles, an uplink power control of the two preambles may determine uplink transmit power of the preamble 1 based on RSRP of a first signal whose communication link performance meets the communication condition, and determine uplink transmit power of the preamble 2 based on RSRP of a first signal whose sensing link performance meets the sensing condition.

Two preamble received target powers (preambleReceivedTargetPower) may be separately set for communication and sensing.
Step 6: If the UE does not receive, in a preset window, a MSG 2 (the MSG 2 is sent by the base station) corresponding to the preamble sent by the UE, the UE re-sends the preamble. In some embodiments, power for re-sending the preamble may be greater than power for sending the preamble in the previous time.
Step 7: Subsequent steps are similar to four-step RACH.

When sending a MSG 3, the UE may send a sensing measurement amount of the first signal or a sensing measurement result of the first signal to the base station.

### Embodiment 2

This embodiment is described by using two-step random access (which may be performed when a downlink sensing requirement arrives) as an example, and includes the following steps:
Step 1: A base station sends first indication information to one or more UEs.

The first indication information is used to indicate at least one of the following:
configuration information or the like of a first signal;
sensing link performance of the first signal;
sensing condition information of the first signal; or
a sensing requirement, where the sensing requirement may be used to instruct UE that obtains, by measuring the first signal, for example, an SSB, sensing link performance meeting a sensing condition to send a preamble to the base station.

The first indication information may be L1 signaling (for example, a MSG 0) carried on a PDCCH, SIB signaling such as a SIB 1, a MAC CE, RRC signaling, paging, or the like.
Step 2: The UE measures N (N≥1) first signals sent by the base station.
Step 3: The UE determines, based on whether the sensing link performance obtained by measuring the first signal meets the sensing condition and/or whether the communication link performance meets a communication condition, whether to send a preamble. In some embodiments:

If sensing link performance of one or more first signals meets the sensing condition and communication link performance of the same first signal meets the communication condition, or sensing link performance of one or more first signals meets the sensing condition and communication link performance of one or more other first signals meets the communication condition, the UE needs to send the preamble. Otherwise, the UE does not need to send the preamble.
Step 4: If the UE determines that the preamble needs to be sent, the UE determines a sending parameter of the preamble (including a time domain resource, a frequency domain resource, a preamble sequence parameter, and the like), which may be as follows:

Method A for determining the sending parameter of the preamble by the UE: determining a target SSB (a type of the first signal) set whose sensing link performance meets the sensing condition and whose communication link performance meets the communication condition; and selecting one or more SSBs from the target SSB set, and determining a sending parameter of a preamble corresponding to the one or more SSBs (if the preamble is sent once, the preamble corresponds to one SSB in the target SSB set whose sensing link performance meets the sensing condition and whose communication link performance meets the communication condition); or
Method B for determining the sending parameter of the preamble by the UE: determining a target SSB set whose sensing link performance meets the sensing condition;
selecting one or more SSBs (an SSB set X) from the target SSB set; determining a target SSB set whose communication link performance meets the communication condition;
selecting one or more SSBs (an SSB set Y) from the target SSB set; and determining a sending parameter of a preamble corresponding to the SSB set X and the SSB set Y, where in this case, the preamble is sent once; or
Method C for determining the sending parameter of the preamble by the UE: determining a target SSB set whose sensing link performance meets the sensing condition; selecting one or more SSBs from the target SSB set, and determining a sensing parameter of a preamble 1 corresponding to the one or more SSBs; determining a target SSB set whose communication link performance meets the communication condition; and selecting one or more SSBs from the target SSB set, and determining a sending parameter of a preamble 2 corresponding to the one or more SSBs, where in this case, the preamble is sent twice.

A sending parameter (including a time domain resource, a frequency domain resource, a preamble sequence format, and the like) of a preamble corresponding to one or more SSBs is configured by the base station and/or defined in a protocol.
Step 5: The UE sends one or more preambles to the base station based on sending parameters that are of the one or more preambles and that are determined in the previous step.

If the UE sends one preamble, an uplink power control of the preamble may determine uplink power of the preamble based on RSRP of the first signal whose communication link performance meets the communication condition.

If the UE sends two preambles, an uplink power control of the two preambles determines uplink transmit power of the preamble 1 based on RSRP of a first signal whose communication link performance meets the communication condition, and determines uplink transmit power of the preamble 2 based on RSRP of a first signal whose sensing link performance meets the sensing condition.

Two preambleReceivedTargetPower may be separately set for communication and sensing.

In addition, a PUSCH part of a MSG A sent by the UE may carry a sensing measurement amount of the first signal or a sensing measurement result of the first signal.
Step 6: If the UE does not receive, in a preset window, a MSG B (the MSG B is sent by the base station) corresponding to the preamble sent by the UE, the UE re-sends the preamble.

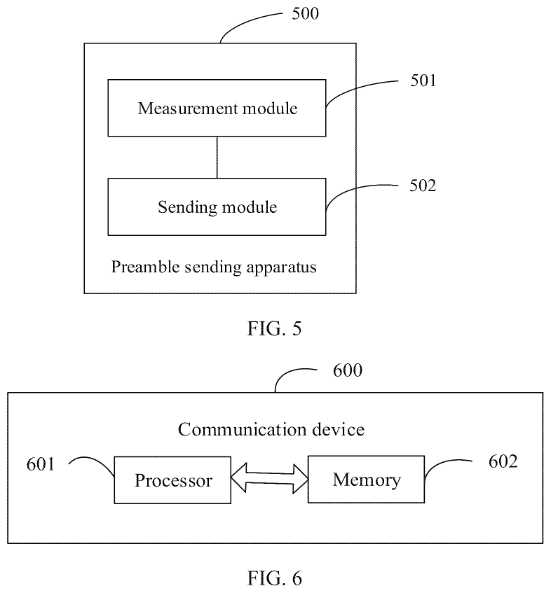

Referring to FIG. 5, FIG. 5 is a structural diagram of a preamble sending apparatus according to an embodiment of this application. As shown in FIG. 5, a preamble sending apparatus 500 includes:
a measurement module 501, configured to measure a first signal to obtain a target measurement result, where the target measurement result includes a sensing measurement result; and
a sending module 502, configured to send a preamble based on the target measurement result.

In some embodiments, the target measurement result further includes a communication measurement result.

In some embodiments, the sending module 502 is configured to send the preamble in a case that the target measurement result meets a preset condition.

In some embodiments, in a case that the target measurement result further includes the communication measurement result, that the target measurement result meets the preset condition includes at least one of the following:
the sensing measurement result meets a first preset condition; or
the communication measurement result meets a second preset condition.

In some embodiments, in a case that the target measurement result includes the sensing measurement result and the communication measurement result,
the target measurement result includes the sensing measurement result and the communication measurement result that are obtained by measuring a same first signal; or
the target measurement result includes: the sensing measurement result obtained by measuring a first signal set, and the communication measurement result obtained by measuring a second signal set, where the first signal set and the second signal set include different first signals.

In some embodiments, the apparatus further includes:
a receiving module, configured to receive first indication information, where the first indication information is used to indicate at least one of the following:
configuration information of the first signal;
a type of the sensing measurement result;
a first preset condition corresponding to the sensing measurement result; or
a measurement requirement.

In some embodiments, the configuration information includes at least one of the following:
a waveform type, a subcarrier spacing, a guard interval, bandwidth, burst duration, a time domain spacing, transmit power, a signal format, a signal direction, a time resource, a frequency domain resource, a quasi co-location QCL relationship, or antenna configuration information.

In some embodiments, the apparatus further includes:
a determining module, configured to determine a preamble sending parameter based on at least one of the sensing measurement result or the communication measurement result, where the communication measurement result is the communication measurement result included in the target measurement result.

In some embodiments, the preamble sending parameter includes at least one of the following:
a preamble sending parameter corresponding to at least one first signal in a third signal set, where the third signal set includes a first signal whose sensing measurement result meets the first preset condition and whose communication measurement result meets the second preset condition;
a preamble sending parameter corresponding to a fourth signal set, where the fourth signal set includes at least one first signal in a fifth signal set and at least one first signal in a sixth signal set; or
a preamble sending parameter corresponding to at least one first signal in the fifth signal set and a preamble sending parameter corresponding to at least one first signal in the sixth signal set; where
the fifth signal set includes a first signal whose sensing measurement result meets the first preset condition, and the sixth signal set includes a first signal whose communication measurement result meets the second preset condition.

In some embodiments, in a case that the preamble sending parameter includes the preamble sending parameter corresponding to the at least one first signal in the fifth signal set and the preamble sending parameter corresponding to the at least one first signal in the sixth signal set, the sending a preamble includes:
sending the preamble based on the preamble sending parameter corresponding to the at least one first signal in the fifth signal set; and
sending the preamble based on the preamble sending parameter corresponding to the at least one first signal in the sixth signal set.

In some embodiments, in a case that the preamble sending parameter includes the preamble sending parameter corresponding to the at least one first signal in the third signal set or the preamble sending parameter corresponding to the fourth signal set, the apparatus sends one preamble, and uplink transmit power of the preamble is determined based on reference signal received power RSRP of a first signal whose communication measurement result meets the second preset condition; or
in a case that the preamble sending parameter includes the preamble sending parameter corresponding to the at least one first signal in the fifth signal set and the preamble sending parameter corresponding to the at least one first signal in the sixth signal set, the apparatus sends two preambles, where uplink transmit power of one preamble is determined based on RSRP of the first signal whose communication measurement result meets the second preset condition, and uplink transmit power of the other preamble is determined based on RSRP of the first signal whose sensing measurement result meets the first preset condition.

In some embodiments, a preamble sending parameter corresponding to each first signal includes at least one of the following:
a sending parameter configured by a network side or a sending parameter defined in a protocol.

In some embodiments, the preamble sending parameter includes at least one of the following:
a time domain resource, a frequency domain resource, or a preamble sequence parameter.

In some embodiments, the sending a preamble includes:
sending a first message, where the first message includes the preamble, and further includes at least one of the following:
a sensing measurement amount for the first signal; or
the sensing measurement result.

In some embodiments, the sensing measurement result includes at least one of the following:
sensing component power of the first signal;
a sensing signal-to-noise ratio (SNR);
a sensing signal-to-interference-plus-noise ratio (SINR);
whether a sensing target exists;
a quantity of sensing targets;
a sensing radar cross-section (RCS);
sensing spectrum information;
a sensing delay;
a sensing distance;
sensing Doppler;
a sensing speed; or
sensing angle information.

In some embodiments, the first preset condition corresponding to the sensing measurement result includes at least one of the following:
the sensing component power of the first signal meets a first threshold condition;
the sensing SNR meets a second threshold condition;
the sensing SINR meets a third threshold condition;
the sensing target exists;
the quantity of sensing targets meets a fourth threshold condition;
the sensing radar cross-section RCS meets a fifth threshold condition;
the sensing spectrum information meets a sixth threshold condition;
the sensing delay meets a seventh threshold condition;
the sensing distance meets an eighth threshold condition;
the sensing Doppler meets a ninth threshold condition;
the sensing speed meets a tenth threshold condition; or
the sensing angle information meets an eleventh threshold condition.

In some embodiments, the communication measurement result includes at least one of the following:
RSRP, a received signal strength indicator (RSSI), a precoding matrix indicator (PMI), a rank indicator (RI), a channel quality indicator (CQI), a signal-to-noise ratio (SNR), a signal-to-interference-plus-noise ratio (SINR), a bit error rate (BER), or a block error rate (BLER).

In some embodiments, the second preset condition corresponding to the communication measurement result includes at least one of the following: the RSRP meets a twelfth threshold condition;
the RSSI meets a thirteenth threshold condition;
the PMI meets a fourteenth threshold condition;
the RI meets a fifteenth threshold condition;
the CQI meets a sixteenth threshold condition;
the SNR meets a seventeenth threshold condition;
the SINR meets an eighteenth threshold condition;
the BER meets a nineteenth threshold condition; or
the BLER meets a twentieth threshold condition.

In some embodiments, the sending a preamble includes:
sending a message MSG 1, where the MSG 1 includes the preamble; or
sending a message MSG A, where the MSG A includes the preamble.

The preamble sending apparatus can improve sensing performance of the terminal.

The preamble sending apparatus in this embodiment of this application may be an electronic device, for example, an electronic device with an operating system, or may be a component such as an integrated circuit or a chip in the electronic device. For example, the electronic device may be a network-side device, or may be another device other than the network-side device. For example, the network-side device may include but is not limited to the types of the network-side device enumerated in the embodiments of this application. Another device may be a server, a Network Attached Storage (NAS), or the like. This is not specifically limited in the embodiments of this application.

The preamble sending apparatus provided in this embodiment of this application can implement the processes implemented in the method embodiment in FIG. 3, and achieve a same technical effect. To avoid repetition, details are not described herein again.

As shown in FIG. 6, an embodiment of this application further provides a communication device 600, including a processor 601 and a memory 602. The memory 602 stores a program or instructions capable of running on the processor 601. For example, when the communication device 600 is a terminal, the program or the instructions are executed by the processor 601 to implement the steps in the foregoing embodiment of the preamble sending method, and a same technical effect can be achieved. To avoid repetition, details are not described herein again.

An embodiment of this application further provides a terminal, including a processor and a communication interface. The communication interface is used as a measurement module configured to: measure a first signal to obtain a target measurement result, where the target measurement result includes a sensing measurement result; and send a preamble based on the target measurement result. This terminal embodiment corresponds to the foregoing method embodiments on a terminal side. Each implementing process and implementation of the foregoing method embodiments may be applicable to this terminal embodiment, and a same technical effect can be achieved.

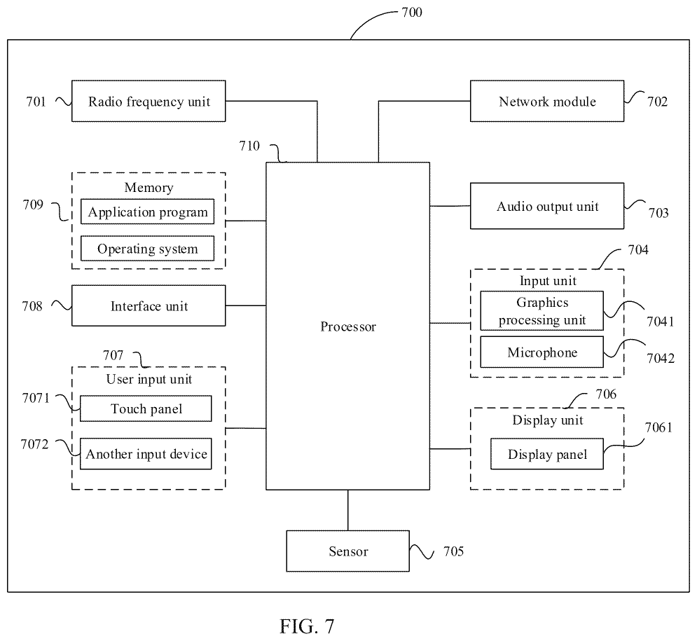

FIG. 7 is a schematic diagram of a hardware structure of a terminal for implementing an embodiment of this application.

The terminal 700 includes but is not limited to at least some components in a radio frequency unit 701, a network module 702, an audio output unit 703, an input unit 704, a sensor 705, a display unit 706, a user input unit 707, an interface unit 708, a memory 709, a processor 710, and the like.

A person skilled in the art may understand that, the terminal 700 may further include a power source (for example, a battery) that supplies power to each component. The power source may be logically connected to the processor 710 by using a power management system, to implement functions such as charging management, discharging management, and power consumption management by using the power management system. The structure of the terminal shown in FIG. 7 does not constitute a limitation on the terminal. The terminal may include more or fewer components than those shown in the figure, or combine some components, or have different component arrangements. Details are not described herein again.

It should be understood that in this embodiment of this application, the input unit 704 may include a Graphics Processing Unit (GPU) 7041 and a microphone 7042, and the graphics processing unit 7041 processes image data of a still picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 or another input device 7072. The touch panel 7071 is also referred to as a touchscreen. The touch panel 7071 may include two parts: a touch detection apparatus and a touch controller. The another input device 7072 may include but is not limited to a physical keyboard, a function key (such as a volume control key or an on/off key), a trackball, a mouse, and an operating lever. Details are not described herein again.

In this embodiment of this application, after receiving downlink data from a network-side device, the radio frequency unit 701 may transmit the downlink data to the processor 710 for processing. In addition, the radio frequency unit 701 may send uplink data to a network-side device. Generally, the radio frequency unit 701 includes but is not limited to an antenna, an amplifier, a transceiver, a coupler, a low-noise amplifier, a duplexer, and the like.

The memory 709 may be configured to store a software program or instructions and various types of data. The memory 709 may mainly include a first storage area for storing a program or instructions and a second storage area for storing data. The first storage area may store an operating system, an application program or instructions required by at least one function (for example, a sound play function or an image play function), and the like. In addition, the memory 709 may include a volatile memory or a non-volatile memory, or the memory 709 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 709 in this embodiment of this application includes but is not limited to these memories and any other suitable type of memory.

The processor 710 may include one or more processing units. In some embodiments, the processor 710 integrates an application processor and a modem processor. The application processor mainly processes operations related to an operating system, a user interface, an application program, and the like. The modem processor, such as a baseband processor, mainly processes a wireless communication signal. It may be understood that, the foregoing modem processor may not be integrated into the processor 710.

The radio frequency unit 701 is configured to: measure a first signal to obtain a target measurement result, where the target measurement result includes a sensing measurement result; and send a preamble based on the target measurement result.

In some embodiments, the target measurement result further includes a communication measurement result.

In some embodiments, the sending a preamble based on the target measurement result includes:
the terminal sends the preamble in a case that the target measurement result meets a preset condition.

In some embodiments, in a case that the target measurement result further includes the communication measurement result, that the target measurement result meets the preset condition includes at least one of the following:
the sensing measurement result meets a first preset condition; or
the communication measurement result meets a second preset condition.

In some embodiments, in a case that the target measurement result includes the sensing measurement result and the communication measurement result,
the target measurement result includes the sensing measurement result and the communication measurement result that are obtained by measuring a same first signal; or
the target measurement result includes: the sensing measurement result obtained by measuring a first signal set, and the communication measurement result obtained by measuring a second signal set, where the first signal set and the second signal set include different first signals.

In some embodiments, before the terminal measures the first signal to obtain the target measurement result, the radio frequency unit 701 is further configured to:
receive first indication information, where the first indication information is used to indicate at least one of the following:
configuration information of the first signal;
a type of the sensing measurement result;
a first preset condition corresponding to the sensing measurement result; or
a measurement requirement.

In some embodiments, the configuration information includes at least one of the following:
a waveform type, a subcarrier spacing, a guard interval, bandwidth, burst duration, a time domain spacing, transmit power, a signal format, a signal direction, a time resource, a frequency domain resource, a quasi co-location QCL relationship, or antenna configuration information.

In some embodiments, before sending the preamble, the radio frequency unit 701 is further configured to:
determine a preamble sending parameter based on at least one of the sensing measurement result or the communication measurement result, where the communication measurement result is the communication measurement result included in the target measurement result.

In some embodiments, the preamble sending parameter includes at least one of the following:
a preamble sending parameter corresponding to at least one first signal in a third signal set, where the third signal set includes a first signal whose sensing measurement result meets the first preset condition and whose communication measurement result meets the second preset condition;
a preamble sending parameter corresponding to a fourth signal set, where the fourth signal set includes at least one first signal in a fifth signal set and at least one first signal in a sixth signal set; or
a preamble sending parameter corresponding to at least one first signal in the fifth signal set and a preamble sending parameter corresponding to at least one first signal in the sixth signal set; where
the fifth signal set includes a first signal whose sensing measurement result meets the first preset condition, and the sixth signal set includes a first signal whose communication measurement result meets the second preset condition.

In some embodiments, in a case that the preamble sending parameter includes the preamble sending parameter corresponding to the at least one first signal in the fifth signal set and the preamble sending parameter corresponding to the at least one first signal in the sixth signal set, the sending a preamble includes:
sending the preamble based on the preamble sending parameter corresponding to the at least one first signal in the fifth signal set; and
sending the preamble based on the preamble sending parameter corresponding to the at least one first signal in the sixth signal set.

In some embodiments, in a case that the preamble sending parameter includes the preamble sending parameter corresponding to the at least one first signal in the third signal set or the preamble sending parameter corresponding to the fourth signal set, the terminal sends one preamble, and uplink transmit power of the preamble is determined based on reference signal received power RSRP of a first signal whose communication measurement result meets the second preset condition; or
in a case that the preamble sending parameter includes the preamble sending parameter corresponding to the at least one first signal in the fifth signal set and the preamble sending parameter corresponding to the at least one first signal in the sixth signal set, the terminal sends two preambles, where uplink transmit power of one preamble is determined based on RSRP of the first signal whose communication measurement result meets the second preset condition, and uplink transmit power of the other preamble is determined based on RSRP of the first signal whose sensing measurement result meets the first preset condition.

In some embodiments, a preamble sending parameter corresponding to each first signal includes at least one of the following:
a sending parameter configured by a network side or a sending parameter defined in a protocol.

In some embodiments, the preamble sending parameter includes at least one of the following:
a time domain resource, a frequency domain resource, or a preamble sequence parameter.

In some embodiments, the sending a preamble includes:
sending a first message, where the first message includes the preamble, and further includes at least one of the following:
a sensing measurement amount for the first signal; or
the sensing measurement result.

In some embodiments, the sensing measurement result includes at least one of the following:
sensing component power of the first signal;
a sensing signal-to-noise ratio SNR;
a sensing signal-to-interference-plus-noise ratio SINR;
whether a sensing target exists;
a quantity of sensing targets;
a sensing radar cross-section RCS;
sensing spectrum information;
a sensing delay;
a sensing distance;
sensing Doppler;
a sensing speed; or
sensing angle information.

In some embodiments, the first preset condition corresponding to the sensing measurement result includes at least one of the following:
the sensing component power of the first signal meets a first threshold condition;
the sensing SNR meets a second threshold condition;
the sensing SINR meets a third threshold condition;
the sensing target exists;
the quantity of sensing targets meets a fourth threshold condition;
the sensing radar cross-section RCS meets a fifth threshold condition;
the sensing spectrum information meets a sixth threshold condition;
the sensing delay meets a seventh threshold condition;
the sensing distance meets an eighth threshold condition;
the sensing Doppler meets a ninth threshold condition;
the sensing speed meets a tenth threshold condition; or
the sensing angle information meets an eleventh threshold condition.

In some embodiments, the communication measurement result includes at least one of the following:

RSRP, a received signal strength indicator RSSI, a precoding matrix indicator PMI, a rank indicator RI, a channel quality indicator CQI, a signal-to-noise ratio SNR, a signal-to-interference-plus-noise ratio SINR, a bit error rate BER, or a block error rate BLER.

In some embodiments, the second preset condition corresponding to the communication measurement result includes at least one of the following:
the RSRP meets a twelfth threshold condition;
the RSSI meets a thirteenth threshold condition;
the PMI meets a fourteenth threshold condition;
the RI meets a fifteenth threshold condition;
the CQI meets a sixteenth threshold condition;
the SNR meets a seventeenth threshold condition;
the SINR meets an eighteenth threshold condition;
the BER meets a nineteenth threshold condition; or
the BLER meets a twentieth threshold condition.

In some embodiments, the sending a preamble includes:
sending a message MSG 1, where the MSG 1 includes the preamble; or
sending a message MSG A, where the MSG A includes the preamble.

The foregoing terminal can improve sensing performance of the terminal.

An embodiment of this application further provides a readable storage medium. The readable storage medium stores a program or instructions, the program or instructions are executed by a processor to implement the processes in the foregoing embodiment of the preamble sending method, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing embodiment of the preamble sending method, and a same technical effect can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor to implement the processes in the foregoing embodiment of the preamble sending method, and a same technical effect can be achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or may be implemented by hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

1. A preamble sending method, comprising:
measuring, by a terminal, a first signal to obtain a target measurement result, wherein the target measurement result comprises a sensing measurement result; and
sending, by the terminal, a preamble based on the target measurement result.

2. The preamble sending method according to claim 1, wherein the target measurement result further comprises a communication measurement result.

3. The preamble sending method according to claim 1, wherein the sending a preamble based on the target measurement result comprises:
sending, by the terminal, the preamble in a case that the target measurement result meets a preset condition.

4. The preamble sending method according to claim 3, wherein when the target measurement result further comprises a communication measurement result, that the target measurement result meets a preset condition comprises at least one of the following:
the sensing measurement result meets a first preset condition; or
the communication measurement result meets a second preset condition.

5. The preamble sending method according to claim 2, wherein the target measurement result comprises the sensing measurement result and the communication measurement result that are obtained by measuring a same first signal; or
the target measurement result comprises: the sensing measurement result obtained by measuring a first signal set, and the communication measurement result obtained by measuring a second signal set, wherein the first signal set and the second signal set comprise different first signals.

6. The preamble sending method according to claim 1, wherein before the measuring, by a terminal, a first signal to obtain a target measurement result, the preamble sending method further comprises:
receiving, by the terminal, first indication information, wherein the first indication information is used to indicate at least one of the following:
configuration information of the first signal;
a type of the sensing measurement result;
a first preset condition corresponding to the sensing measurement result; or
a measurement requirement.

7. The preamble sending method according to claim 6, wherein the configuration information comprises at least one of the following:
a waveform type, a subcarrier spacing, a guard interval, bandwidth, burst duration, a time domain spacing, transmit power, a signal format, a signal direction, a time resource, a frequency domain resource, a quasi co-location (QCL) relationship, or antenna configuration information.

8. The preamble sending method according to claim 2, wherein before the sending a preamble, the preamble sending method further comprises:
determining a preamble sending parameter based on at least one of the sensing measurement result or the communication measurement result, wherein the communication measurement result is the communication measurement result comprised in the target measurement result.

9. The preamble sending method according to claim 8, wherein the preamble sending parameter comprises at least one of the following:
a preamble sending parameter corresponding to at least one first signal in a third signal set, wherein the third signal set comprises a first signal whose sensing measurement result meets a first preset condition and whose communication measurement result meets a second preset condition;
a preamble sending parameter corresponding to a fourth signal set, wherein the fourth signal set comprises at least one first signal in a fifth signal set and at least one first signal in a sixth signal set; or
a preamble sending parameter corresponding to at least one first signal in the fifth signal set and a preamble sending parameter corresponding to at least one first signal in the sixth signal set,
wherein the fifth signal set comprises a first signal whose sensing measurement result meets the first preset condition, and the sixth signal set comprises a first signal whose communication measurement result meets the second preset condition.

10. The preamble sending method according to claim 9, wherein when the preamble sending parameter comprises the preamble sending parameter corresponding to the at least one first signal in the fifth signal set and the preamble sending parameter corresponding to the at least one first signal in the sixth signal set, the sending a preamble comprises:
sending the preamble based on the preamble sending parameter corresponding to the at least one first signal in the fifth signal set; and
sending the preamble based on the preamble sending parameter corresponding to the at least one first signal in the sixth signal set.

11. The preamble sending method according to claim 9, wherein when the preamble sending parameter comprises the preamble sending parameter corresponding to the at least one first signal in the third signal set or the preamble sending parameter corresponding to the fourth signal set, the terminal sends one preamble, and uplink transmit power of the preamble is determined based on reference signal received power (RSRP) of the first signal whose communication measurement result meets the second preset condition; or
when the preamble sending parameter comprises the preamble sending parameter corresponding to the at least one first signal in the fifth signal set and the preamble sending parameter corresponding to the at least one first signal in the sixth signal set, the terminal sends two preambles, wherein uplink transmit power of one preamble is determined based on RSRP of the first signal whose communication measurement result meets the second preset condition, and uplink transmit power of the other preamble is determined based on RSRP of the first signal whose sensing measurement result meets the first preset condition.

12. The preamble sending method according to claim 9, wherein a preamble sending parameter corresponding to each first signal comprises at least one of the following:
a sending parameter configured by a network side or a sending parameter defined in a protocol.

13. The preamble sending method according to claim 8, wherein the preamble sending parameter comprises at least one of the following:
a time domain resource, a frequency domain resource, or a preamble sequence parameter.

14. The preamble sending method according to claim 1, wherein the sending a preamble comprises:
sending a first message, wherein the first message comprises the preamble, and further comprises at least one of the following:
a sensing measurement amount for the first signal; or
the sensing measurement result.

15. The preamble sending method according to claim 6, wherein the sensing measurement result comprises at least one of the following:
sensing component power of the first signal;
a sensing signal-to-noise ratio (SNR);
a sensing signal-to-interference-plus-noise ratio (SINR);
whether a sensing target exists;
a quantity of sensing targets;
a sensing radar cross-section (RCS);
sensing spectrum information;
a sensing delay;
a sensing distance;
sensing Doppler;
a sensing speed; or
sensing angle information.

16. The preamble sending method according to claim 15, wherein the first preset condition corresponding to the sensing measurement result comprises at least one of the following:
the sensing component power of the first signal meets a first threshold condition;
the sensing SNR meets a second threshold condition;
the sensing SINR meets a third threshold condition;
the sensing target exists;
the quantity of sensing targets meets a fourth threshold condition;
the sensing radar cross-section (RCS) meets a fifth threshold condition;
the sensing spectrum information meets a sixth threshold condition;
the sensing delay meets a seventh threshold condition;
the sensing distance meets an eighth threshold condition;
the sensing Doppler meets a ninth threshold condition;
the sensing speed meets a tenth threshold condition; or
the sensing angle information meets an eleventh threshold condition.

17. The preamble sending method according to claim 2, wherein the communication measurement result comprises at least one of the following:
RSRP, a received signal strength indicator (RSSI), a precoding matrix indicator (PMI), a rank indicator (RI), a channel quality indicator (CQI), a signal-to-noise ratio (SNR), a signal-to-interference-plus-noise ratio (SINR), a bit error rate (BER), or a block error rate (BLER).

18. The preamble sending method according to claim 17, wherein a second preset condition corresponding to the communication measurement result comprises at least one of the following:
the RSRP meets a twelfth threshold condition;
the RSSI meets a thirteenth threshold condition;
the PMI meets a fourteenth threshold condition;
the RI meets a fifteenth threshold condition;
the CQI meets a sixteenth threshold condition;
the SNR meets a seventeenth threshold condition;
the SINR meets an eighteenth threshold condition;
the BER meets a nineteenth threshold condition; or
the BLER meets a twentieth threshold condition.

19. The preamble sending method according to claim 1, wherein the sending a preamble comprises:
sending a message MSG 1, wherein the MSG 1 comprises the preamble; or
sending a message MSG A, wherein the MSG A comprises the preamble.

20. A terminal, comprising: a memory storing a computer program; and a processor coupled to the memory and configured to execute the computer program to perform operations comprising:
measuring a first signal to obtain a target measurement result, wherein the target measurement result comprises a sensing measurement result, and
sending a preamble based on the target measurement result.
